(19) United States
(12) Patent Application Publication
(10) Pub. No.: US 2006/0220517 A1
(43) Pub. Date: Oct. 5, 2006

(54) Display device

(75) Inventors: Seung-Hyun Son, Suwon-si (KR); Hyoung-Bin Park, Suwon-si (KR); Hidekazu Hatanaka, Suwon-si (KR); Sang-Hun Jang, Suwon-si (KR); Gi-Young Kim, Suwon-si (KR); Sung-Soo Kim, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/366,394

(22) Filed: Mar. 3, 2006

(30) Foreign Application Priority Data
Mar. 29, 2005 (KR) 10-2005-0025976

(51) Int. Cl. H01J 29/10

(52) U.S. Cl. 313/461

(57) ABSTRACT

A display device including a first electrode and a second electrode separated from each other, and an electron accelerating layer, in which electrons accelerate when a voltage is applied between the first and second electrodes, is arranged between the first and second electrodes. A plurality of excitation gas particles are injected into the electron accelerating layer and sealed therein to generate UV rays after being excited by electrons accelerated in the electron accelerating layer. A phosphor layer emits visible rays after being excited by the UV rays.

### CROSS-REFERENCE TO RELATED APPLICATION

This application claims priority to and the benefit of Korean Patent Application No. 10-2005-0025976, filed on Mar. 29, 2005, which is hereby incorporated by reference for all purposes as if fully set forth herein.

### BACKGROUND OF THE INVENTION

1. Field of the Invention

The present invention relates to a display device, and more particularly, to a display device with a low driving voltage and high luminous efficiency.

2. Discussion of the Background

Generally, a plasma display panel (PDP) displays an image using an electrical discharge. In PDPs, plasma discharge occurs by applying an alternating current (AC) or direct current (DC) voltage between electrodes, and ultraviolet (UV) rays generated by the discharge excite a phosphor material, which emits visible rays.

PDPs may be facing discharge or surface discharge PDPs according to electrode arrangement. A facing discharge PDP has a pair of sustain electrodes that are respectively formed on an upper substrate and a lower substrate, and discharge occurs perpendicular to the substrates. A surface discharge PDP has a pair of sustain electrodes that are formed on the same substrate, and discharge occurs parallel to the substrates.

FIG. 1 is an exploded perspective view showing a conventional surface discharge PDP. FIG. 2A and FIG. 2B are perpendicular and vertical cross sectional views of the PDP of FIG. 1.

Referring to FIG. 1, FIG. 2A, and FIG. 2B, a conventional PDP may include a lower substrate 10 and an upper substrate 20 facing each other with a discharge space therebetween, in which plasma discharge occurs. A plurality of address electrodes 11 are formed on a surface of the lower substrate 10, and a first dielectric layer 12 covers the address electrodes 11. A plurality of discharge cells 14 are formed by partitioning the discharge space with a plurality of barrier ribs 13, which are formed at predetermined intervals to prevent electrical and optical cross-talk between adjacent discharge cells 14. Phosphor layers 15, which produce red, green, and blue light, are coated in the discharge cells 14, and a discharge gas fills the discharge cells 14.

The upper substrate 20 is a transparent substrate, which transmits visible rays, and it is coupled to the lower substrate 10, on which the barrier ribs 13 are formed. A plurality of sustain electrode pairs 21a and 21b are formed on a surface of the upper substrate 20, and they are arranged orthogonally to the address electrodes 11. The sustain electrodes 21a and 21b are usually formed of a transparent conductive material, such as indium tin oxide (ITO), to transmit visible rays. Also, narrow metallic bus electrodes 22a and 22b are formed on the sustain electrodes 21a and 21b to reduce the sustain electrodes' line resistance. A transparent second dielectric layer 23 covers the sustain electrodes 21a and 21b and the bus electrodes 22a and 22b. A protective layer 24, which may be made of magnesium oxide (MgO), covers the second dielectric layer 23. The protective layer 24 prevents plasma sputtering damage to the second dielectric layer 23, and it emits secondary electrons, thereby lowering a discharge voltage.

In such a conventional PDP, plasma discharge occurs as the discharge gas ionizes inside the discharge cells 14. As the discharge gas stabilizes from an excited state, it emits UV rays. The UV rays excite the phosphor layers 15 to emit visible rays, which form an image. However, the conventional PDP requires a lot of energy to ionize the discharge gas in order to generate UV rays. Hence, it has poor energy efficiency. Therefore, the driving voltage is high and luminous efficiency is low due to the conventional PDP's low energy efficiency.

### SUMMARY OF THE INVENTION

The present invention provides a display device with a low driving voltage and high luminous efficiency.

Additional features of the invention will be set forth in the description which follows, and in part will be apparent from the description, or may be learned by practice of the invention.

The present invention discloses a display device including a first electrode and a second electrode separated from each other, and an electron accelerating layer, in which electrons accelerate when a voltage is applied between the first and second electrodes, is arranged between the first and second electrodes. A plurality of excitation gas particles are in the electron accelerating layer to generate UV rays after being excited by electrons accelerated in the electron accelerating layer, and a phosphor layer emits visible rays after being excited by the UV rays.

The present invention also discloses a display device including a first electrode and a second electrode separated from each other, an electron accelerating layer, in which electrons accelerate when a voltage is applied between the first and second electrodes, is arranged between the first and second electrodes, and an excitation gas layer is arranged between the second electrode and the electron accelerating layer. The excitation gas layer includes a plurality of excitation gas particles to generate UV rays after being excited by the electrons accelerated in the electron accelerating layer, and a phosphor layer emits visible rays after being excited by the UV rays.

The present invention also discloses a display device including a first electrode and a second electrode separated from each other, a first electron accelerating layer, in which electrons are accelerated when a voltage is applied between the first and second electrodes, is arranged on a first surface of the first electrode, and a second electron accelerating layer, in which electrons are accelerated when a voltage is applied between the first and second electrodes, is arranged on a first surface of the second electrode. An excitation gas layer is arranged between the first and second electron accelerating layers and includes a plurality of excitation gas particles to generate UV rays after being excited by accelerated electrons emitted from one of the first and second electron accelerating layers. A phosphor layer emits visible rays after being excited by the UV rays.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view showing a conventional surface discharge PDP.

FIG. 2A and FIG. 2B are perpendicular and vertical cross-sectional views of the PDP of FIG. 1.

FIG. 3 is a schematic cross-sectional view showing a display device according to a first embodiment of the present invention.

FIG. 4 is a cross-sectional view showing a modification of the display device of FIG. 3.

FIG. 5 is a schematic cross-sectional view of a display device according to a second embodiment of the present invention.

FIG. 6A and FIG. 6B are views showing the UV spectrum emitted from excited species of N₂ gas particles, and the transmittance of UV rays through a front panel, respectively.

FIG. 7 is a cross-sectional view showing a modification of the display device of FIG. 5.

FIG. 8 is a schematic cross-sectional view showing a display device according to a third embodiment of the present invention.

FIG. 9 is a schematic cross-sectional view showing a display device according to a fourth embodiment of the present invention.

FIG. 10 is a schematic cross-sectional view showing a display device according to a fifth embodiment of the present invention.

FIG. 11 is a schematic cross-sectional view showing a display device according to a sixth embodiment of the present invention.

FIG. 12 is a schematic cross-sectional view showing a display device according to a seventh embodiment of the present invention.

### DETAILED DESCRIPTION OF THE ILLUSTRATED EMBODIMENTS

The present invention will now be described more fully with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element such as a layer, film, region or substrate is referred to as being “on” another element, it can be directly on the other element or intervening elements may also be present. In contrast, when an element is referred to as being “directly on” another element, there are no intervening elements present.

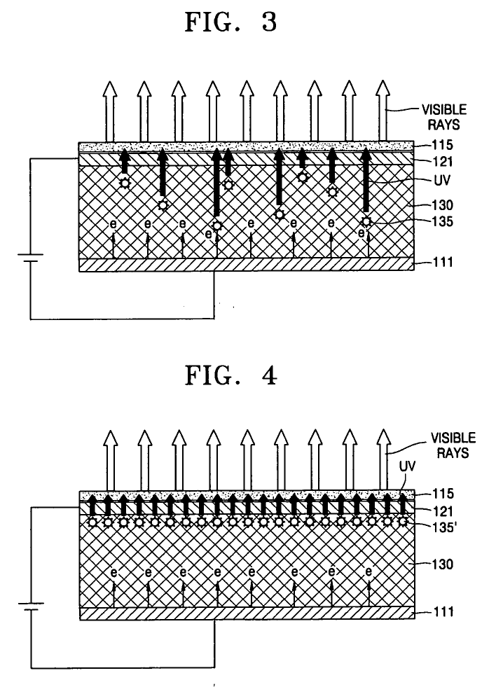

FIG. 3 is a cross-sectional view showing a portion (i.e. a sub-pixel) of a display device according to a first embodiment of the present invention.

Referring to FIG. 3, a first electrode 111 and a second electrode 121 are arranged facing each other with a predetermined space therebetween. Here, the first electrode 111 and the second electrode 121 are arranged to cross each other. The second electrode 121 may be made of indium tin oxide (ITO), which is a transparent conductive material. An electron accelerating layer 130 is arranged between the first and second electrodes 111 and 121. Electrons accelerate in the electron accelerating layer 130 when a applying predetermined voltage between the first and second electrodes 111 and 121. The electron accelerating layer 130 may be made of oxidized porous silicon or carbon nanotubes (CNT). The oxidized porous silicon may be oxidized porous polycrystalline silicon (polysilicon) or oxidized porous amorphous silicon. In —FIG. 3, the first electrode 111 and the second electrode 121 are shown as a cathode and an anode, respectively, and a DC voltage is applied between the first and second electrodes 111 and 121. In this case, electrons migrate from the first electrode 111 to the electron accelerating layer 130 and then accelerate through the electron accelerating layer 130 towards the second electrode 121. Alternatively, an AC voltage may be applied between the first and second electrodes 111 and 121. In this case, electrons from the first electrode 111 and the second electrode 121 alternately migrate to the electron accelerating layer 130 toward the second electrode 121 and the first electrode 111, respectively.

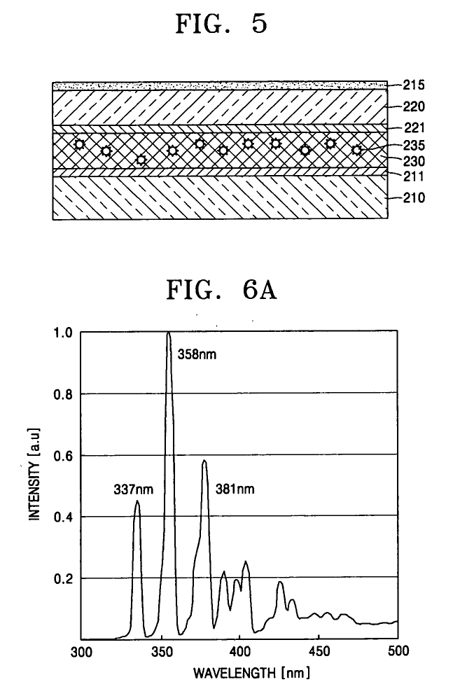

A plurality of excitation gas particles 135 may be injected into the electron accelerating layer 130 and sealed therein. Accelerated electrons in the electron accelerating layer 130 excite the excitation gas particles 135, which generate UV rays. The excitation gas particles 135 may produce long wavelength UV rays having a high transmittance rate. The excitation gas particles 135 may include Xe, N₂, D₂ (i.e. heavy hydrogen), CO₂, H₂, CO, and Kr gas particles or a mixture of gas particles including any combination of these gas particles. Long wave gas particles, such as N₂ gas particles, are more preferable. The excitation gas particles may be injected into an electron accelerating layer by a bonding method, such as anodic bonding in a gas particle filled chamber. The gas particles may also be directly injected into the electron accelerating layer by ion implantation. Furthermore, the gas particles are sealed in the electron accelerating layer because the electron accelerating layer may be sealed by first and second substrates (shown in FIG. 5, for example) and a sealing member, e.g. frit glass, (not shown), which couples the substrates together.

A phosphor layer 115 is arranged on the second electrode 121. In the display device for forming an image, the phosphor layer 115 produces red, green, or blue light for each pixel. The phosphor layer 115 is excited by UV rays generated by the excitation gas particles 135 within the electron accelerating layer 130, thereby emitting visible rays of a predetermined color.

In the display device of FIG. 3, electrons migrated into the electron accelerating layer 130 accelerate within the electron accelerating layer 130 when applying a predetermined voltage between the first and second electrodes 111 and 121. The accelerated electrons excite the excitation gas particles 135 inside the electron accelerating layer 130, and the excitation gas particles 135 generate UV rays by stabilizing from their excited state. The UV rays excite the phosphor layer 115 after transmitting through the second electrode 121, and the phosphor layer 115 emits visible rays of a predetermined color to form a desired image.

As such, the display device according to the present embodiment needs sufficient energy to excite the excitation gas particles 135. Hence, it may be driven with a lower driving voltage than a conventional PDP, which requires sufficient energy to ionize a discharge gas. For is example, while a conventional PDP may need 12.13 eV or more to ionize Xe when Xe is used as the discharge gas, the display device of the present embodiment requires 8.28-12.13 eV to excite Xe when Xe particles are used as the excitation gas particles 135.

Additionally, the driving voltage of the present embodiment may be further reduced because the electrons accelerated in the electron accelerating layer 130 may have about 5 eV more energy than the electrons emitted to the outside after being accelerated in the electron accelerating layer 130. This is because the electrons accelerated in the electron accelerating layer 130 substantially do not lose energy due to a surface work function, or scatting between electrodes and the electrons. Also, since the electrons accelerated in the electron accelerating layer 130 excite the excitation gas particles 135 in the electron accelerating layer 130, the possibility of deteriorating the second electrode 121 due to the collision of electrons decreases. Therefore, the display device's life span may be extended due to the stability of the second electrode 121.

FIG. 4 is a cross-sectional view showing a modification of the display device of FIG. 3. Referring to FIG. 4, excitation gas particles 135′ are located in an upper portion of the electron accelerating layer 130, which is closer to the second electrode 121 than the first electrode 111. In this case, UV rays generated by the excitation gas particles 135′ may reach the phosphor layer 115 without any substantial loss caused by the electron accelerating layer 130.

FIG. 5 is a schematic cross-sectional view showing a portion (i.e. a sub-pixel) of a display device according to a second embodiment of the present invention.

Referring to FIG. 5, a first substrate 210, which is a lower substrate, and a second substrate 220, which is an upper substrate, are arranged facing each other with a predetermined space therebetween. The first and second substrates 210 and 220 may be transparent glass substrates. The first and second substrates 210 and 220 may also be flexible substrates, such as plastic substrates, to manufacture a flexible display device.

A first electrode 211 is arranged on an inner surface of the first substrate 210, and a second electrode 221 is arranged on an inner surface of the second substrate 220 and in a direction crossing the first electrode 211 so that unit sub-pixels may be selected to display images. The second electrode 221 may be made of ITO. An electron accelerating layer 230 is arranged between the first electrode 211 and the second electrode 221. Electrons migrated into the electron accelerating layer 230 accelerate when applying a predetermined voltage between the first and second electrodes 211 and 221. An AC or DC voltage may be applied between the first and second electrodes 211 and 221. The electron accelerating layer 230 may be made of oxidized porous silicon or CNTs. The oxidized porous silicon may be oxidized porous polysilicon or oxidized porous amorphous silicon.

A plurality of excitation gas particles 235, which generate UV rays after being excited by accelerated electrons, may be injected into the electron accelerating layer 230 and sealed therein. The excitation gas particles 235 may produce long wavelength UV rays having a high transmittance as described above, and they may include Xe, N₂, D₂ (i.e. heavy hydrogen), CO₂, H₂, CO, and Kr gas particles or a mixture of gas particles including any combination of these gas particles. Long wave gas particles, such as N₂ gas particles, are more preferable.

A phosphor layer 215 is arranged on an outer surface of the second substrate 220. The UV rays generated by the excitation gas particles 235 transmit through the second electrode 221 and the second substrate 220 to excite the phosphor layer 215, which emits visible rays of a predetermined color.

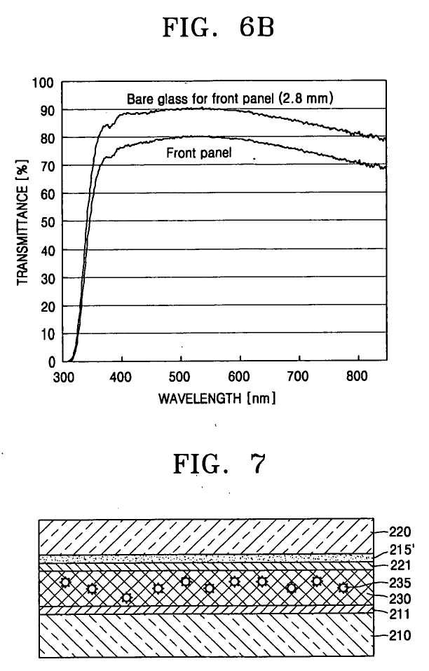

FIG. 6A is a graph of a UV spectrum obtained from excited species of N₂ gas particles when the N₂ gas particles are used as excitation gas particles. FIG. 6B is a graph showing the transmittance of UV rays when UV rays emitted from the excited species of N₂ gas particles transmit through an ITO electrode and a 2.8 mm thick glass substrate (i.e. a front panel).

Referring to FIG. 6A and FIG. 6B, UV rays with wavelengths of 337, 358, and 381 nm emit from the species of N₂ gas particles, and the transmittance of these UV rays through the front panel is about 31, 66, and 73%, respectively. Accordingly, UV rays generated inside an electron accelerating layer may transmit through an ITO electrode and a glass substrate to sufficiently excite a phosphor layer.

FIG. 7 is a cross-sectional view showing a modification of the display device of FIG. 5. Referring to FIG. 7, a phosphor layer 215′ may be arranged between the second substrate 220 and the second electrode 221.

FIG. 8 is a schematic cross-sectional view showing a portion (i.e. a sub-pixel) of a display device according to a third embodiment of the present invention.

Referring to FIG. 8, a first substrate 310 and a second substrate 320 are arranged facing each other with a predetermined space therebetween. The first and second substrates 310 and 320 may be glass substrates or flexible substrates.

First and second electrodes 311 and 321 are arranged on inner surfaces of the first and second substrates 310 and 320, respectively, and the first and second electrodes 311 and 321 are arranged in a direction crossing each other so that unit sub-pixels may be selected to display images. An electron accelerating layer 330, in which migrated electrons accelerate when applying a predetermined voltage between the first and second electrodes 311 and 321, is formed as wide as the first and second electrodes 311 and 321 and arranged between the first and second electrodes 311 and 321. An AC or DC voltage may be applied between the first and second electrodes 311 and 321. The electron accelerating layer 330 may be made of oxidized porous silicon or CNTs. The oxidized porous silicon may be oxidized porous polysilicon or oxidized porous amorphous silicon. A plurality of excitation gas particles 335 may be injected into the electron accelerating layer 330 and sealed therein. The phosphor layer 315 is arranged between the first and second substrates 310 and 320 and on both sides of the first and second electrodes 311 and 321 and the electron accelerating layer 330.

In the display device of FIG. 8, electrons migrated into the electron accelerating layer 330 accelerate when applying a predetermined voltage between the first and second electrodes 311 and 321. The accelerated electrons excite the excitation gas particles 335, which emit UV rays. The UV rays excite the phosphor layer 315, which emits visible rays having a predetermined color. The visible rays emit through the second substrate 320, which is an upper substrate, to form an image.

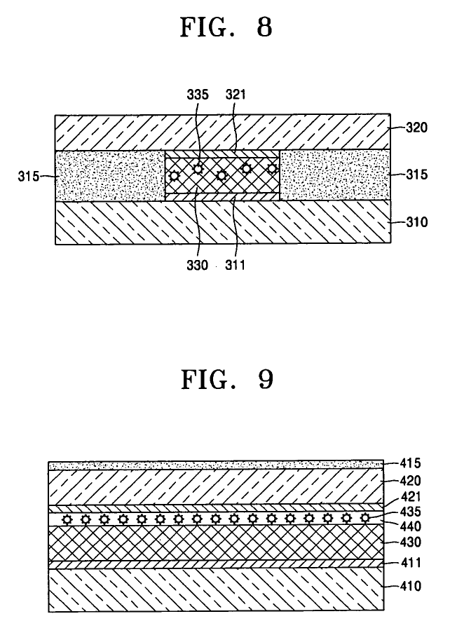

FIG. 9 is a schematic cross-sectional view showing a portion (i.e. a sub-pixel) of a display device according to a fourth embodiment of the present invention.

Referring to FIG. 9, a first substrate 410, which is a lower substrate, and a second substrate 420, which is an upper substrate, are arranged facing each other with a predetermined space therebetween. The first and second substrates 410 and 420 may be glass substrates or flexible substrates. First and second electrodes 411 and 421 are arranged on inner surfaces of the first and second substrates 410 and 420, respectively, and the first and second electrodes 411 and 421 are arranged in a direction crossing each other so that unit sub-pixels may be selected to display images. The second electrode 421 may be made of ITO. An electron accelerating layer 430, in which migrated electrons accelerate when applying a predetermined voltage between the first and second electrodes 411 and 421, is arranged on the first electrode 411. An AC or DC is voltage may be applied between the first and second electrodes 411 and 421. The electron accelerating layer 430 may be made of oxidized porous silicon or CNTs. The oxidized porous silicon may be oxidized porous polysilicon or oxidized porous amorphous silicon.

An excitation gas layer 440 is arranged between the electron accelerating layer 430 and the second electrode 421. The excitation gas layer 440 includes a plurality of excitation gas particles 435, which generate UV rays when excited by electrons emitted from the electron accelerating layer 430 after being accelerated in the electron accelerating layer 430. The excitation gas layer may be made by injecting gas particles into a space, such as a space defined by substrates, electron accelerating layers, electrodes, phosphor layers, etc. FIG. 9 shows the excitation gas layer 440 arranged in the space between the electron accelerating layer 430 and the second electrode 421. The excitation gas particles are sealed in the space. The excitation gas particles 435 may produce long wavelength UV rays having a high transmittance as described above, and the gas particles may include Xe, N₂, D₂ (i.e. heavy hydrogen), CO₂, H₂, CO, and Kr gas particles or a mixture of gas particles including any combination of these gas particles. Long wave gas particles, such as N₂ gas particles, are more preferable. A phosphor layer 415 is arranged on an outer surface of the second substrate 420 to emit visible rays of a predetermined color after being excited by the UV rays from the excitation gas layer 440.

In the display device of FIG. 9, when applying a predetermined voltage between the first and second electrodes 411 and 421, electrons migrate into the electron accelerating layer 430, accelerate, and are emitted out of the electron accelerating layer 430. The emitted electrons excite the excitation gas particles 435 in the excitation gas layer 440, and the excitation gas particles 435 generate UV rays. The UV rays generated in the excitation gas layer 440 transmit through the second electrode 421 and the second substrate 420 to excite the phosphor layer 415, which emits visible rays to form an image.

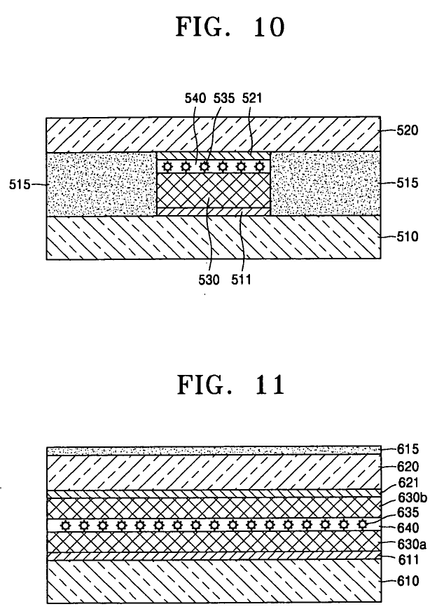

FIG. 10 is a schematic cross-sectional view showing a portion (i.e. a sub-pixel) of a display device according to a fifth embodiment of the present invention.

Referring to FIG. 10, a first substrate 510 and a second substrate 520 are arranged facing each other with a predetermined space therebetween. The first and second substrates 510 and 520 may be glass substrates or flexible substrates. First and second electrodes 511 and 521 are arranged on inner surfaces of the first and second substrates 510 and 520, respectively, and the first and second electrodes 511 and 521 are arranged in a direction crossing each other so that unit sub-pixels may be selected to display images. An electron accelerating layer 530, in which migrated electrons accelerate when applying a predetermined voltage between the first and second electrodes 511 and 521, is as wide as the first and second electrodes 511 and 521 and arranged on the first electrode 511. An AC or DC voltage may be applied between the first and second electrodes 511 and 521. The electron accelerating layer 530 may be made of oxidized porous silicon or CNTs. The oxidized porous silicon may be oxidized porous polysilicon or oxidized porous amorphous silicon.

An excitation gas layer 540, which is as wide as the electron accelerating layer 530, is arranged between the electron accelerating layer 530 and the second electrode 521. The excitation gas layer 540 includes a plurality of excitation gas particles 535, which generate UV rays when excited by electrons emitted from the electron accelerating layer 530 after being accelerated in the electron accelerating layer 530. A phosphor layer 515 is arranged between the first and second substrates 510 and 520 and on both sides of the first and second electrodes 511 and 521, the electron accelerating layer 530, and the excitation gas layer 540.

In the display device of FIG. 10, electrons emitted from the electron accelerating layer 530 excite the excitation gas particles 535 in the excitation gas layer 540, and the excitation gas particles 535 generate UV rays. The UV rays from the excitation gas layer 540 excite the phosphor layer 515, which generates visible rays of a predetermined color. The visible rays emit through the second substrate 520, which is an upper substrate, and form an image.

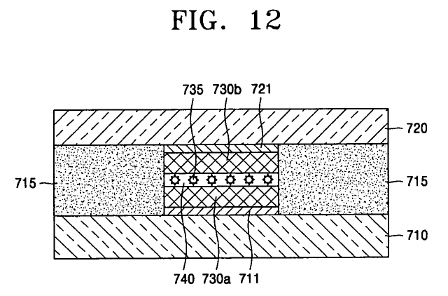

FIG. 11 is a schematic cross-sectional view showing a portion (i.e. a sub-pixel) of a display device according to a sixth embodiment of the present invention.

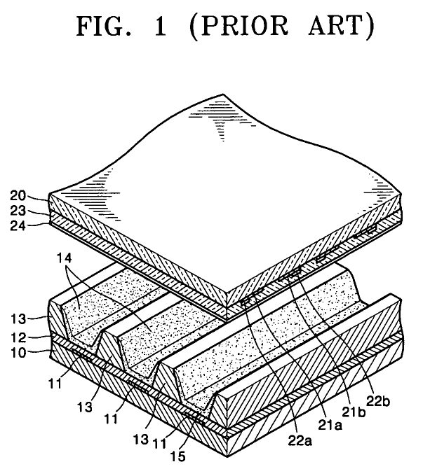

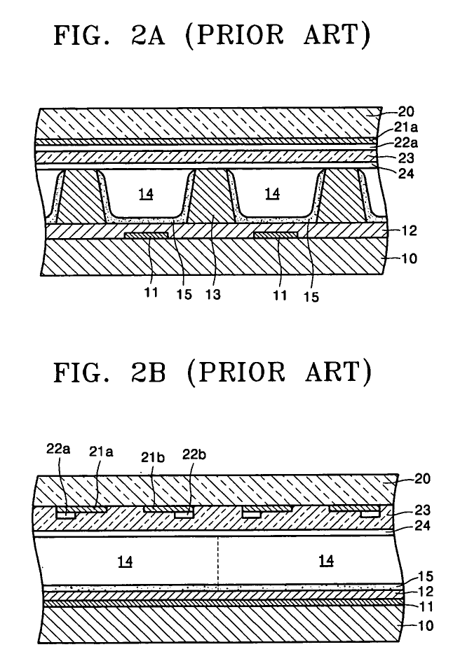

Referring to FIG. 1, a first substrate 610, which is a lower substrate, and a second substrate 620, which is an upper substrate, are arranged facing each other with a predetermined space therebetween. The first and second substrates 610 and 620 may be glass substrates or flexible substrates. First and second electrodes 611 and 621 are arranged on inner surfaces of the first and second substrates 610 and 620, respectively, and the first and second electrodes 611 and 621 are arranged in a direction crossing each other so that unit sub-pixels may be selected to display images. The second electrode 621 may be made of ITO.

A first electron accelerating layer 630a, in which electrons migrating from the first electrode 611 to the second electrode 621 accelerate, is arranged on the first electrode 611. A second electron accelerating layer 630b, in which electrons migrating from the second electrode 621 to the first electrode 611 accelerate, is arranged on the second electrode 621. The first and second electron accelerating layers 630a and 630b may be made of oxidized porous silicon or CNTs. The oxidized porous silicon may be oxidized porous polysilicon or oxidized porous amorphous silicon. An excitation gas layer 640 is arranged between the first electron accelerating layer 630a and the second electron accelerating layer 630b. The excitation gas layer 640 includes a plurality of excitation gas particles 635, which generate UV rays when excited by electrons emitted from the first and second electron accelerating layers 630a and 630b. The excitation gas particles 635 may include Xe, N₂, D₂ (i.e. heavy hydrogen), CO₂, H₂, CO, and Kr gas particles or a mixture of gas particles including any combination of these gas particles. Long wave gas particles, such as N₂ gas particles, are more preferable.

A phosphor layer 615 is arranged on the second substrate 620 to emit visible rays of a predetermined color after being excited by UV rays from the excitation gas layer 640.

In the display device of FIG. 11, when applying an AC voltage across the first and second electrodes 611 and 621, electrons accelerated in the first electron accelerating layer 630a and electrons accelerated in the second electron accelerating layer 630b alternately emit into the excitation gas layer 640. The emitted electrons excite the excitation gas particles 635 in the excitation gas layer 640, and the excitation gas particles 635 generate UV rays. The UV rays from the excitation gas layer 640 excite the phosphor layer 615 after transmitting through the second electron accelerating layer 630b, the second electrode 621, and the second substrate 620. Consequently, visible rays emit from the phosphor layer 615, thereby forming an image.

FIG. 12 is a schematic cross-sectional view showing a portion (i.e. a sub-pixel) of a display device according to a seventh embodiment of the present invention.

Referring to FIG. 12, a first substrate 710 and a second substrate 720 are arranged facing each other with a predetermined space therebetween. The first and second substrates 710 and 720 may be glass substrates or flexible substrates. First and second electrodes 711 and 721 are arranged on inner surfaces of the first and second substrates 710 and 720, respectively.

A first electron accelerating layer 730a, in which electrons migrating from the first electrode 711 to the second electrode 721 accelerate, is as wide as the first electrode 711 and arranged on the first electrode 711, and a second electron accelerating layer 730b, in which electrons migrating from the second electrode 721 to the first electrode 711 accelerate, is as wide as the second electrode 721 and arranged on the second electrode 721. The first and second electron accelerating layers 730a and 730b may be made of oxidized porous silicon or CNTs. The oxidized porous silicon may be oxidized porous polysilicon or oxidized porous amorphous silicon. An excitation gas layer 740 is as wide as the first and second electron accelerating layers 730a and 730b and arranged between the first and second electron accelerating layers 730a and 730b. The excitation gas layer 740 includes a plurality of excitation gas particles 735, which generate UV rays when excited by electrons emitted from the first and second electron accelerating layers 730a and 730b. A phosphor layer 715 is arranged between the first and second substrates 710 and 720 and on both sides of the first and second electrodes 711 and 721, the first and second electron accelerating layers 730a and 730b, and the excitation gas layer 740.

In the display device of FIG. 12, when applying an AC voltage between the first and second electrodes 711 and 721, electrons accelerated in the first electron accelerating layer 730a, and electrons accelerated in the second electron accelerating layer 730b, alternately emit into the excitation gas layer 740. The emitted electrons excite the excitation gas particles 735 in the excitation gas layer 740, and the excitation gas particles generate UV rays. The UV rays from the excitation gas layer 740 excite the phosphor layer 715, which generates visible rays of a predetermined color. The visible rays transmit through the second substrate 720, which is an upper substrate, to form an image.

As described above, a display device according to the present invention excites excitation gas particles, and thus requires a lower driving voltage than that of a conventional PDP, which ionizes a discharge gas. Additionally, a display device according to the present invention may have higher luminous efficiency than a conventional PDP.

Furthermore, embodiments of the present invention may be applied as large-scale display devices or backlights for liquid crystal display (LCD) devices, and may be applied to flexible display devices when using flexible substrates. When embodiments of the present invention are applied as a backlight for an LCD device, the first and second electrodes may be arranged substantially in parallel with each other, rather than crossing each other as described above.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display device, comprising:
a first electrode and a second electrode separated from each other;
an electron accelerating layer arranged between the first electrode and the second electrode and in which electrons accelerate when a voltage is applied between the first electrode and the second electrode;
a plurality of excitation gas particles in the electron accelerating layer to generate ultraviolet rays after being excited by electrons accelerated in the electron accelerating layer; and
a phosphor layer to emit visible rays after being excited by the ultraviolet rays.

2. The display device of claim 1, wherein the electron accelerating layer comprises oxidized porous silicon or carbon nanotubes.

3. The display device of claim 2, wherein the oxidized porous silicon comprises oxidized porous polycrystalline silicon or oxidized porous amorphous silicon.

4. The display device of claim 1, wherein the excitation gas particles comprise at least gas particles selected from the group consisting of Xe, N₂, D₂, CO₂, H₂, CO, and Kr.

5. The display device of claim 1, wherein the phosphor layer is arranged on the second electrode.

6. The display device of claim 5, wherein the excitation gas particles are closer to the second electrode than to the first electrode.

7. The display device of claim 5, wherein the second electrode comprises indium tin oxide.

8. The display device of claim 1, further comprising:
a first substrate; and
a second substrate,
wherein the first electrode is arranged on the first substrate and the second electrode is arranged on the second substrate.

9. The display device of claim 8, wherein the first substrate and the second substrate comprise glass.

10. The display device of claim 8, wherein the first substrate and the second substrate are flexible substrates.

11. The display device of claim 8, wherein the phosphor layer is arranged on an outer surface of the second substrate.

12. The display device of claim 8, wherein the phosphor layer is arranged on an inner surface of the second substrate.

13. The display device of claim 8, wherein the phosphor layer is arranged between the first substrate and the second substrate and on both sides of the electron accelerating layer.

14. The display device of claim 1, wherein the first electrode and the second electrode are arranged to cross each other.

15. The display device of claim 1, wherein the first electrode and the second electrode are arranged substantially in parallel with each other.

16. A display device, comprising:
a first electrode and a second electrode separated from each other;
an electron accelerating layer arranged between the first electrode and the second electrode and in which electrons accelerate when a voltage is applied between the first electrode and the second electrode;
an excitation gas layer arranged between the second electrode and the electron accelerating layer, the excitation gas layer including a plurality of excitation gas particles to generate ultraviolet rays after being excited by electrons accelerated in the electron accelerating layer; and
a phosphor layer to emit visible rays after being excited by the ultraviolet rays.

17. The display device of claim 16, wherein the electron accelerating layer comprises oxidized porous silicon or carbon nanotubes.

18. The display device of claim 17, wherein the oxidized porous silicon comprises oxidized porous polycrystalline silicon or oxidized porous amorphous silicon.

19. The display device of claim 16, wherein the excitation gas particles comprise at least gas particles selected from the group consisting of Xe, N₂, D₂, CO₂, H₂, CO, and Kr.

20. The display device of claim 16, further comprising:
a first substrate; and
a second substrate,
wherein the first electrode is arranged on the first substrate and the second electrode is arranged on the second substrate.

21. The display device of claim 20, wherein the first substrate and the second substrate comprise glass.

22. The display device of claim 20, wherein the first substrate and the second substrate are flexible substrates.

23. The display device of claim 20, wherein the phosphor layer is arranged on an outer surface of the second substrate.

24. The display device of claim 20, wherein the phosphor layer is arranged on an inner surface of the second substrate.

25. The display device of claim 20, wherein the phosphor layer is arranged between the first substrate and the second substrate and on both sides of the electron accelerating layer.

26. The display device of claim 16, wherein the first electrode and the second electrode are arranged to cross each other.

27. The display device of claim 16, wherein the first electrode and the second electrode are arranged substantially in parallel with each other.

28. A display device, comprising:
a first electrode and a second electrode separated from each other;
a first electron accelerating layer arranged on a first surface of the first electrode and in which electrons accelerate when a voltage is applied between the first electrode and the second electrode;
a second electron accelerating layer arranged on a first surface of the second electrode and in which electrons accelerate when a voltage is applied between the first electrode and the second electrode;
an excitation gas layer arranged between the first electron accelerating layer and the second electron accelerating layer, the excitation gas layer including a plurality of excitation gas particles to generate ultraviolet rays after being excited by electrons emitted from one of the first electron accelerating layer and the second electron accelerating layer; and
a phosphor layer to emit visible rays after being excited by the ultraviolet rays.

29. The display device of claim 28, wherein an alternating current voltage is applied between the first electrode and the second electrode.

30. The display device of claim 28, wherein the first electron accelerating layer and the second electron accelerating layer each comprise oxidized porous silicon or carbon nanotubes.

31. The display device of claim 30, wherein the oxidized porous silicon comprises oxidized porous polycrystalline silicon or oxidized porous amorphous silicon.

32. The display device of claim 28, wherein the excitation gas particles comprise at least gas particles selected from the group consisting of Xe, N₂, D₂, CO₂, H₂, CO, and Kr.

33. The display device of claim 28, further comprising:
a first substrate; and
a second substrate,
wherein a second surface of the first electrode is arranged on the first substrate and a second surface of the second electrode is arranged on the second substrate.

34. The display device of claim 33, wherein the first substrate and the second substrate comprise glass.

35. The display device of claim 33, wherein the first substrate and the second substrate are flexible substrates.

36. The display device of claim 33, wherein the phosphor layer is arranged on an outer surface of the second substrate.

37. The display device of claim 33, wherein the phosphor layer is arranged on an inner surface of the second substrate.

38. The display device of claim 33, wherein the phosphor layer is arranged between the first substrate and the second substrate and on both sides of the first electron accelerating layer and the second electron accelerating layer.

39. The display device of claim 28, wherein the first electrode and the second electrode are arranged to cross each other.

40. The display device of claim 28, wherein the first electrode and the second electrode are arranged substantially in parallel with each other.
